(19) United States
(12) Patent Application Publication
(10) Pub. No.: US 2009/0008554 A1
(43) Pub. Date: Jan. 8, 2009

(54) METHOD FOR INFRARED IMAGING OF LIVING OR NON-LIVING OBJECTS INCLUDING TERRAINS THAT ARE EITHER NATURAL OR MANMADE

(75) Inventors: John Douglas Weir, Huntington, NY (US); Robert John Christ, Brentwood, NY (US); Nils Jakob Fonneland, Lake Grove, NY (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Northrop Grumman Corporation, Los Angeles, CA (US)

(21) Appl. No.: 11/946,604

(22) Filed: Nov. 28, 2007

Related U.S. Application Data
(63) Continuation-in-part of application No. 11/742,751, filed on May 1, 2007.
Application No. 11/742,751 is a continuation-in-part of application No. 11/506,701, filed on Aug. 18, 2006.
Application No. 11/506,701 is a continuation-in-part of application No. 10/971,217, filed on Oct. 22, 2004, now Pat. No. 7,164,146.

(51) Int. Cl. G01J 5/00

(52) U.S. Cl. 250/338.1

(57) ABSTRACT

An improved system for infrared (IR) imaging of terrain is disclosed wherein or or more IR cameras may be used at one or more locations to record images at multiple focal planes. The images are all taken of the same field of view but at varied focal planes. Global Positioning Satellite (GPS) may be used to track each camera location and each camera captures images of the object. Information regarding the orientation of the camera may also be measured. The digital information from the images from each camera at varying focal planes, the distance from the object to each camera, orientation of camera and the GPS location of each camera is transferred to a computer where the data is processed through the use of merging and photogrammetry software utilizing appropriate algorithms to convert the multiple images into a two-dimensional or three-dimensional image with improved depth of field.

### CROSS REFERENCE TO RELATED APPLICATIONS

This application is a continuation-in-part of U.S. patent application Ser. No. 11/742,751 filed May 1, 2007, which is a continuation-in-part of U.S. patent application Ser. No. 11/506,701 filed Aug. 18, 2006, which is a continuation-in-part of U.S. patent application Ser. No. 10/971,217 filed Oct. 22, 2004, both of which are herein incorporated by reference.

### GOVERNMENT CONTRACT

United States Government has certain rights to this invention pursuant to the funding and/or contracts awarded by the Strategic Environmental Research and Development Program (SERDP) in accordance with the Pollution Prevention Project WP-0407. SERDP is a congressionally mandated Department of Defense (DOD), Department of Energy (DOE) and Environmental Protection Agency (EPA) program that develops and promotes innovative, cost-effective technologies.

### FIELD OF THE INVENTION

The present invention relates to improved infrared imaging of living or non-living objects including terrains that are either natural or manmade, and more particularly relates to image enhancement of objects that may be camouflaged in the normal visible or IR spectrums.

### BACKGROUND INFORMATION

Radiation in the infrared range is of longer wavelength than visible light. The different wavelength of Infrared Radiation (IR) has several unique characteristics. For instance, materials that are opaque to visible light may be transparent to infrared, and vice-versa. Infrared is much less subject to scattering and absorption and infrared cannot be seen by the human eye. Also, unlike visible light, which is given off by ordinary objects only at very high temperatures, infrared energy is emitted by all objects at room temperatures and lower. This means that infrared radiation makes objects detectable in the dark. Different objects give off varying amounts of infrared energy, depending on the temperature of the object and their emissivity. IR cameras are designed to sense differing amounts of infrared energy coming from the various areas of a scene by focal plane array detector and to convert them to corresponding intensities of visible light by electronics for display purposes.

However, Depth of Field (DOF) in IR cameras is limited similar to standard optical systems. In optics, DOF is the distance in front of and behind the subject which appears to be in focus. For any given lens setting, there is only one distance at which a subject is precisely in focus, and focus falls off gradually on either side of that distance, so there is a region in which the blurring is tolerable often termed “circle of confusion”. IR cameras similarly have only one distance at which a subject is precisely in focus. This limits the depth an observer is able to see in the image.

The present invention has been developed in view of the foregoing.

### SUMMARY OF THE INVENTION

In one embodiment, a single IR camera may be used to capture multiple image of the same scene from along a common optical axis. These images are then merged to provide an image with improved depth of field.

In one embodiment, multiple IR cameras set a know distance apart record images of the same scene from different angles at multiple focal planes for a set field of view. The data from each image is transferred to a computer which merges the focused portions of the multiple images into one focused image with improved depth of field. The merger of the stacked images occurs through the use of appropriate algorithms which may also convert the data through photogrammetry into a three-dimensional image.

In another embodiment of the invention, multiple IR cameras are used at different locations to record images from multiple focal planes. The images are all taken of the same object(s) from varying perspectives. Global Positioning Satellite (GPS) tracks each camera location and each camera captures images of the object. The digital information from the images from each camera at varying focal planes, the distance from the object to each camera, orientation of camera and the GPS location of each camera is transferred to a computer where the data is processed through the use of photogrammetry and appropriate algorithms into a three-dimensional image.

It is an aspect of this invention to provide an imaging system, comprising a infrared camera, a first image generated at a first focal plane, a second image generated at a second focal plane, means for determining the distance from the camera to the first and second focal planes and means for combining the first and second image into a single image with improved depth of field.

Another aspect of the present invention is to provide an imaging system, comprising a first infrared camera located at a first position, a first image generated by the first infrared camera at a first focal plane, a second image generated by the first infrared camera at a second focal plane, a second infrared camera located at a second position, a third image generated by the second infrared camera at a third focal plane, a fourth image generated by the second infrared camera at a fourth focal plane and means for merging the first image with the second image and for merging third image with the fourth image.

These and other aspects will become apparent from the following detailed description.

### BRIEF DESCRIPTION OF THE DRAWINGS

FIG. 1 shows a single IR camera acquiring multiple images at varying focal planes with a scene according to one embodiment of the present invention.

FIG. 2 is a flowchart depicting a process by which a single infrared camera may acquire and merge multiple images at varying focal planes according to one embodiment of the present invention.

FIG. 3 shows the elevation angle, A, roll angle, B, and azimuth angle, C, which may be measured and incorporated in the image data according to one embodiment of the present invention.

FIG. 4 shows how two IR cameras equipped with GPS may be used to triangulate points within a scene according to one embodiment of the present invention.

FIG. 5 shows how multiple IR cameras may be used from different perspectives to acquire images at multiple focal planes within the same scene according to one embodiment of the present invention.

FIG. 6 is a flowchart depicting a process by which multiple infrared cameras may be used to acquire and merge multiple images at varying focal planes according to one embodiment of the present invention.

FIG. 7 shows infrared cameras mounted on aircraft used to capture improved depth of field images from multiple locations.

### DETAILED DESCRIPTION

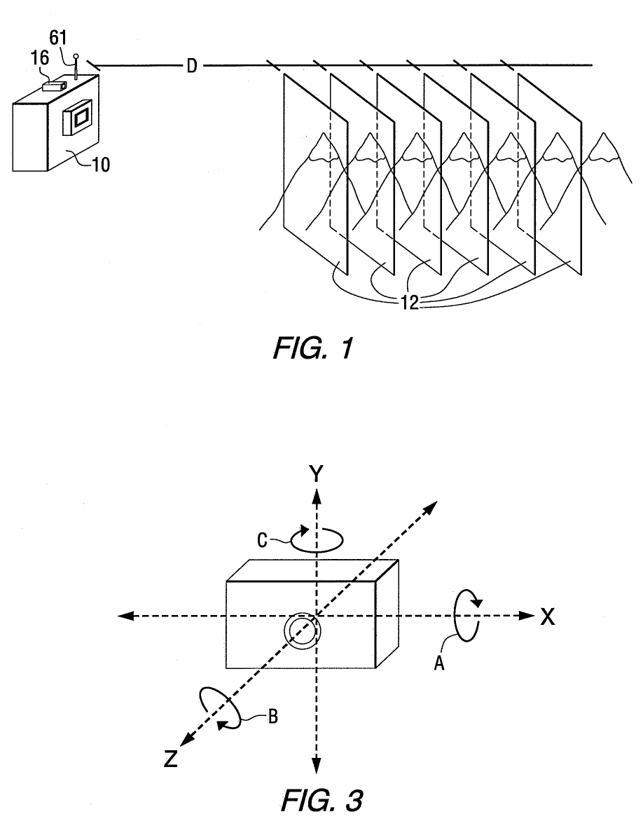

Infrared cameras convert IR radiation (˜750 nm to 1 mm) to a digital signal based on the wavelength of the radiation. As the makeup of terrain changes so too does the IR radiation produced by the surface. IR cameras are able to detect these changes and portray them as an image. Focal planes 12 are described and visualized as two dimensional as shown in FIG. 1. As commonly used, the term “focal plane” refers to planes, perpendicular to the optic axis, which pass through the front and rear focus points behind the lens of the camera. As used herein the term “focal plane” refers to a plane, perpendicular to the optic axis, which passes through the front focus point, i.e. a plane within the object space unless expressly indicated to have a different meaning. The term “optic axis” refers to an imaginary line perpendicular to the lens of a camera and passing through the center of the lens. As used herein the term “image” refers to a visual representation of an object or scene which may be stored electronically or displayed as a photograph or through an electronic display, e.g. an LCD screen, a CRT monitor, a plasma display, an OLED screen, a PHOLED, a plotter or a printer. As described above, increased and decreased depth around the focal plane remains visible but less focused as distance from the focal plane is increased.

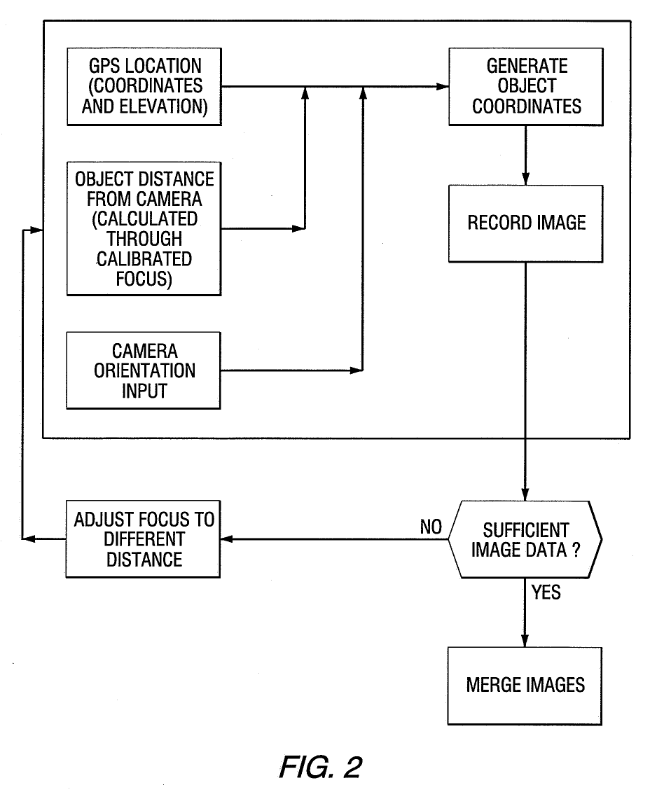

With reference now to FIG. 1 and FIG. 2, an IR camera 10 may be used to capture multiple images within the same field of view. Camera 10 focus is adjusted to capture images at focal planes 12 having different distances, D, from the camera 10 along a common optical axis. Images captured while an IR camera is in one location with one orientation share a common optical axis. The camera, 10, may be equipped with a GPS receiver 61 and a range finder 16 which may be a laser. The GPS receiver 61 is used to identify the location of the camera 10 and the range finder 16 can measure the distance, D, from the camera 10 to objects within each focal plane 12. The captured images of the same scene can then be merged into one image of the scene having improved depth of field. Coordinate data may also be incorporated into the merged image based on distances from the GPS coordinates of the camera 10 to objects in each focal plane 12 acquired by the range finder 16. The flowchart shown in FIG. 2 provides a overview of the process by which multiple images are acquired and merged.

In one embodiment the camera 10 may be further equipped with theodolite equipment or other camera attitude equipment to improve the accuracy of the coordinates generated within the image. As used herein, “attitude equipment” refers to measurement equipment for determining the elevation angle, roll angle and azimuth angle of the camera relative to local gravity. In this embodiment, the camera 10 may be equipped so that, as seen in FIG. 3, the elevation angle, A, the roll, B, and the azimuth angle, is known and may be compensated for in the final coordinate determination.

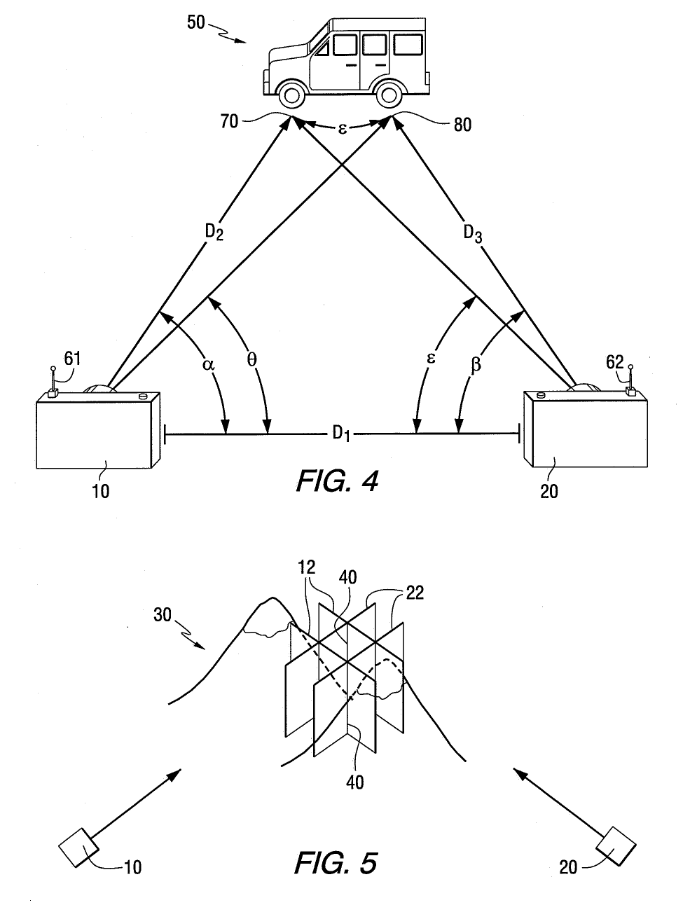

FIG. 4 illustrates a two camera 10, 20 embodiment of the present invention and shows how the two IR cameras may be utilized to detect the range, size and coordinates of distant objects 50. The distance, D1 between the cameras 10,20 may be known or may be determined through the use of range finders or GPS receivers 61, 62 accompanying the cameras 10, 20. Similarly, distances, D2 and D3, may be known or may be calculated through the use of a range finder, for example, a laser. In another embodiment, the D2 and/or D3 can be calculated through triangulation. Intersection points 70,80 can be readily calculated by way of triangulation. In this embodiment each camera must be equipped so that, with reference to in FIG. 3, the elevation angle, A, the roll, B, and the azimuth angle, C, is known and may be compensated for in the final measurement. In yet another embodiment, the focus of the camera may be calibrated so that the D2 and/or D3 is determined by adjustment of the focus of the camera 10,20. In yet another embodiment and again referring to FIG. 4, if the distance between the cameras is known (α−θ) and (β−ε) can give the size of an object 50 within a known field of view of the cameras 10,20. If the object 50 is moving the angular rate of change of one or both cameras 10,20 may be used to calculate the velocity and acceleration of the object 50.

With reference now to FIG. 5, the present invention improves the infrared inspection of terrains by providing the observer with clearer two-dimensional images and available three-dimensional views of the terrain. In this embodiment, two IR cameras 10,20 are directed at the same scene 30 but from different perspectives or lines of sight. Each camera 10, 20 generates images of the scene 30 at different focal planes 12,22. For purposes of illustration only two focal planes 12 are shown for the first camera 10 and two focal planes 22 for the second camera 20. However, more images at different focal planes 12,22 would be used. Similarly, only two cameras 10,20 are shown, but additional cameras may be used to improve the final three dimensional image. The images generated at differing focal planes 12 may then be merged into a single first image from the perspective of the first camera 10 with an improved depth of field. A second image with improved depth of field may also be generated from the perspective of the second camera 20 by merging the images of the differing focal planes 22. As described in more detail below, the data from the merged images two-dimensional images can then be further combined to yield a three-dimensional image of the scene 30. Points along focal plane intersections 40 can be used to determine coordinates within the scene 30 through the use of known algorithms commonly used in photogrammetry.

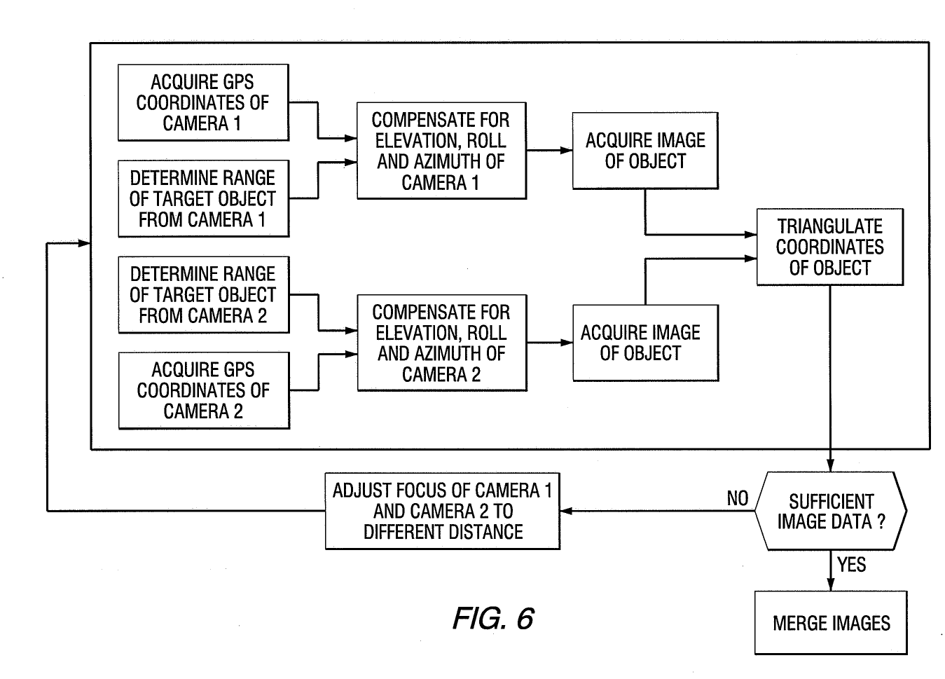

Referring now to the flowchart in FIG. 6, the process for multiple camera image acquisition is described. Two or more cameras are arranged in different locations. Each camera has a line of sight at the same object scene. It should be noted that the cameras may be hand-held, stand-mounted, or vehicle-mounted. The location of each camera is first determined. This may be accomplished through the use of a GPS receiver accompanying the camera or the location may be known. The range of a target object in the focal plane is then determined. At this point distance between the cameras is known and distance to an object in intersecting focal planes has been determined. Each camera may also be equipped with attitude equipment. The attitude data provides elevation angle, azimuth angle and roll angle for each camera which may be used to compensate for errors in or replace the distance data from each camera to the focal plane of interest. An image is then acquired with each camera. Coordinates within each image can then be calculated. This process is repeated several times until a sufficient amount of data is available to produce an acceptable image. Software embedded in the camera or communicated to a remote device merges the 2-dimensional images from each camera perspective into an image having improved depth of field. The 2-dimensional image may also have coordinate information inserted into the image. In one embodiment the 2-dimensional images are further combined by the embedded software to produce 3-dimensional renderings of the terrain.

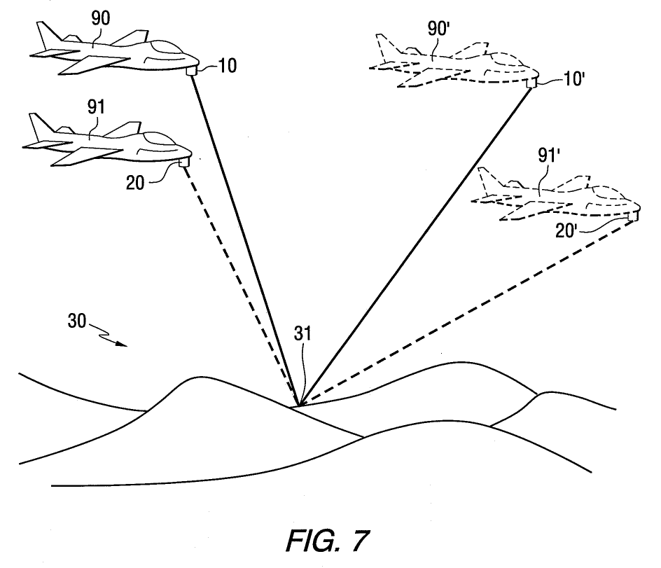

In one embodiment shown in FIG. 7, the camera 10 is mounted on a aircraft 90. Multiple infrared images are then acquired at different locations. Again, the distance of each focal plane may be determined through the use of a range finder. The roll, azimuth and elevation angles of the camera are then recorded as well as the elevation of the aircraft 90. In flight GPS records the coordinates of the camera for each photo taken. The photos at the different locations are merged into improved depth of field images with coordinate and elevation information. The improved images may then be transformed into 3-dimensional graphical images.

The recorded images are merged or stacked using software using appropriate algorithms to process the digital data of each image. The algorithm uses the focused depth for each image to produce an image that is in focus for a much greater depth of field than could be achieved using traditional methods. The software incorporates algorithms to select the focused portion of each image. The portion of individual images used is a function of the number of images selected to be taken between the top focal plane and the bottom focal plane. The focused portion of each image is stacked with the focused portions of the other images. The stack is then merged to create one image. The software produces an image that is in focus for a much greater depth of field than could be achieved using traditional methods. In fact, depth of field is primarily limited by the number images produced at differing focal planes.

In another embodiment also illustrated in FIG. 7, a first IR camera 10 may be mounted on an first aircraft 90, such as a plane or a helicopter. While and aircraft is used in this embodiment for illustration the IR camera can be located on any vehicle, such as a wheeled vehicle or tracked vehicle without deviating from the invention. The IR camera 10 acquires multiple images while focused on an object 31 within a scene 30 when the aircraft 90 is at a first position. Additional images focused on the same object 31 within the scene to can subsequently be captured when the aircraft 90′ is at another position. The images may then be merged into 2-dimensional image or processed into 3-dimensional renderings. In another embodiment, a second aircraft 91 with a second IR camera 20 also captures images of the same scene. The data is then relayed back to a central unit where it can be processed photogrammetrically and through merging to produce an improved rendering of the scene. As described above, each aircraft is equipped with a GPS receiver so the coordinates of the aircraft when an image is acquired is known. Attitude equipment may also be incorporated into each camera 10, 20 so that azimuth, roll and elevation angles is factored into the algorithms determining the combined image. Additionally, the elevation of the aircraft may also be accounted for and utilized in the algorithms combining the images.

Whereas particular embodiments of this invention have been described above for purposes of illustration, it will be evident to those skilled in the art that numerous variations of the details of the present invention may be made without departing from the invention as defined in the appended claims.

1. An imaging system, comprising:
a infrared camera;
a first image generated at a first focal plane;
a second image generated at a second focal plane;
means for determining the distance from the camera to the first and second focal planes; and
means for combining the first and second image into a single image with improved depth of field.

2. The imaging system of claim 1, wherein the means for determining the distance to the first and second focal planes is a laser range finder.

3. The imaging system of claim 1, wherein the means for combining the images at the different focal plane into one image comprises a computer in communication with the infrared camera and software installed on the computer capable of combining the images into one merged image.

4. The imaging system of claim 3, wherein the first and second focal planes are perpendicular to an optical axis of the infrared camera.

5. The imaging system of claim 1, wherein at least three images are taken at at least three different focal planes.

6. The imaging system of claim 5, wherein the infrared camera is repositioned whereby at least one of the at least three different focal planes intersects another of the at least three different focal planes.

7. The imaging system of claim 6, wherein the images are combined using merging software and photogrammetry software.

8. An imaging system, comprising:
a first infrared camera located at a first position;
a first image generated by the first infrared camera at a first focal plane;
a second image generated by the first infrared camera at a second focal plane;
a second infrared camera located at a second position;
a third image generated by the second infrared camera at a third focal plane;
a fourth image generated by the second infrared camera at a fourth focal plane; and
means for merging the first image with the second image and for merging third image with the fourth image.

9. The imaging system of claim 8, wherein the images are further combining by photogrammetry.

10. The imaging system of claim 9, wherein the first and second camera are equipped with GPS receivers.

11. The imaging system of claim 10, wherein at least one of the first and second cameras are equipped with attitude equipment.

12. The imaging system of claim 11, wherein the second camera is mounted on a vehicle.

13. The imaging system of claim 12, wherein the vehicle is an aircraft.
